(19) United States
(12) Patent Application Publication
(10) Pub. No.: US 2008/0121121 A1
(43) Pub. Date: May 29, 2008

(54) Two Dimensional And Three Dimensional Structures And Process For Producing Same

(75) Inventors: Arie Hendrik Frans Van Vliet, Arnhem (NL); Leo Arthur Everhard Teering, Dieren (NL)

Correspondence Address: OLIFF & BERRIDGE, PLC, P.O. BOX 320850, ALEXANDRIA, VA, 22320-4850, US

(73) Assignee: Colbond B.V., Arnhem (NL)

(21) Appl. No.: 11/664,435

(22) PCT Filed: Nov. 22, 2005
(86) PCT No.: PCT/EP2005/012477

§ 371 Date: Mar. 30, 2007

(30) Foreign Application Priority Data
Nov. 26, 2004 (EP) 04028178.4

(51) Int. Cl. B30B 15/00

(52) U.S. Cl. 100/38

(57) ABSTRACT

The invention pertains to two dimensional structures in particular grid like structures and to three dimensional structures in particular truss-like structures.

The invention furthermore pertains to a process that allows production of these structures in a cheap and simple way.

A grid like structure can be obtained by a roll press forming process wherein a quantity of the material is deposited into the nip between a first and second counter rotating roll and the material is pressed between the two rolls. The two counter rotating rolls comprise grooves substantially parallel to each other and the grooves on the first and second roll cross each other when the rolls counter rotate.

A truss like structure can be obtained by a roll press forming process wherein one of the two counter rotating rolls having a corrugated cross section running tangential around the surface of the roll and said corrugated surface comprises grooves which intersect, the second of the two counter rotating rolls having solely a corrugated cross section running tangential around the surface of the second roll and being complementary to the corrugated surface of the first roll.

The invention pertains to a process for producing two dimensional or three dimensional structures. The process according to the invention comprises the steps of heating a quantity of a fusible material, heating is performed until the material has a viscosity sufficiently low to be used in a roll press forming process, depositing a quantity of the material into the nip between a first and second counter rotating roll and pressing the material between the two rolls.

A similar process is disclosed in U.S. Pat. No. 3,478,138 that pertains to a method of making thermoplastic articles in continuous strips having non-planar surface contours. The polymeric material is pressed between two counter rotating rolls. At least one of the two rolls has a contoured surface.

The invention also pertains to two and three dimensional structures. Such structures can be used for various applications e.g. as reinforcement elements. In particular the invention pertains to truss-like structures.

The engineering of large constructions is often characterized by what is called truss structures. A truss is a engineered structure of short individual framing members assembled usually in a triangular pattern into a rigid support structure.

Each member is usually subjected to longitudinal stress only, either tension or compression. The entire structure acts as a beam.

The reason these structure are used is that they provide the optimum in terms of weight/performance.

Examples of this can be seen in for example large spans like the roof construction of big halls and other building structures, but also in lightweight racing cars and airplanes. These structures are usually built by joining separate elements in various ways. When building smaller constructions, this is not practical because the separate elements from which to build become too small. One then usually applies monolithic structures. Another way of making constructions of intermediate size is the use of shell structures. The shells either consist of solid material or a composite of a core material which acts as a distance holder between the sheets on the outer sides. The core not only has the function of distance holder, but also provides shear strength to give the composite structure its strength and stiffness.

For the core of such sandwich structures one applies usually foam materials or honeycomb structures which can be made of material varying from cardboard to aramid paper depending on budget and technical requirements. In principle one could beneficially apply a truss structure but the fact that there is no method available to make such structures economically at the sizes required prohibits this.

When making three dimensional sandwich structures most of the present possibilities are very limited: It is difficult to give a three dimensional shape to honeycombs and foams. For foams one could use an injection moulding technique as applied in e.g. polyurethane, but this also has its limitations.

It is known that small or relatively thin truss-like structures can be made using an injection moulding technique. The disadvantage of this technique is that it yields structures limited in size because of the moulds to be used. The cycle time is relatively high limiting the production output. The material needs to fulfil certain requirements in order to fill the mould completely.

It is thus an object of the present invention to overcome the disadvantages of the prior art and to provide two dimensional structures in particular grid like structures and three dimensional structures in particular truss-like structures for a competitive price that can be used in mass applications. It is another object of the present invention to provide a process that allows production of these structures in a cheap and simple way.

Surprisingly it has been found that the object to provide two dimensional structures in particular grid like structures can be achieved by a process comprising the steps of heating a quantity of a fusible material, heating is performed until the material has a viscosity sufficiently low to be used in a roll press forming process depositing a quantity of the material into the nip between a first and second counter rotating roll pressing the material between the two rolls characterised in that the two counter rotating rolls comprise grooves substantially parallel to each other, said grooves are arranged in an angle from 0° to 90° measured against the rolls circumferential direction which is perpendicular to the rolls centre axis and the grooves on the first and second roll cross each other when the rolls counter rotate. The surfaces of the first and second roll are complementary to the final product.

It is preferred that the two counter rotating rolls are partially immersed in a cooling liquid, more preferably the two counter rotating rolls are half immersed in water.

The advantage of immersing the two counter rotating rolls in a cooling liquid is very efficient cooling of the pressed material immediately after it leaves the counter rotating rolls. The pressed material that is still viscous after it leaves the counter rotating rolls is thus solidified immediately after pressing. Further deformation of the material can thus be avoided. In addition, the material detaches from the rolls very easily as the surface of the rolls on which the material is pressed is moistened. The process is a one step process that allows mass production of said structures in a continuous way.

In a preferred embodiment the distance between the grooves is essentially constant and the grooves run essentially in straight lines. However, it is also possible that sinusoidal shaped grooves are milled on the rolls. The shape of the grooves can be triangular, rectangular, trapezoidal or curved. It has to be pointed out that said grooves not necessarily have a constant cross section or constant depth and that they may vary in shape and/or depth.

The grooves are arranged in an angle from 0° to 90° measured against the rolls circumferential, i.e. tangential direction which is perpendicular to the rolls centre axis. The grooves on the first and second roll cross each other when the rolls counter rotate. Such a process yields a grid like structure comprising two plies of parallel members, one on top of the other, lying crossed and being connected at the crossing points. The areas circumscribed by the two plies of parallel members are rectangular in shape when the sum of the above mentioned angles on the first and second roll amounts to 900, e.g. the first roll comprises grooves parallel to circumferential direction (0°) and the second roll comprises grooves in an angle of 90° against circumferential direction or the first roll comprises grooves in an angle of 20° against circumferential direction and the second roll comprises grooves in an angle of 70° against circumferential direction. Said areas only differ regarding their position comparative to the longitudinal direction of the structure. If the sum of the angels is less than 90° the openings in the grid-like structure are of rhombical shape.

Of course it is also possible to equip only the one roll with grooves that cross each other in a grid pattern and leave the other roll in cylindrical shape without any surface contour. Though this would lead to a grid, this grid would not consist of two plies.

The process of the invention accepts at its input a large variety of materials, varying in terms of shape, colour, melt viscosity and/or impurities. It is possible that the material to be pressed between the two counter rotating contoured rolls comprises a metal alloy preferably an aluminium alloy.

It is however preferred that the material to be pressed between the two counter rotating contoured rolls is a polymeric material. The polymeric material may be a composition of one or more polymer types.

Basically all kinds of polymeric materials —provided it can be heated such that it will flow out of an extruder—can be used. It is also possible to use fibre reinforced polymeric material. The types of polymers introduced into the process are preferably selected from the group containing polyester, polyamide, polyethylene, polypropylene, polyvinylchloride, polystyrene and/or mixtures thereof.

In a preferred embodiment the material to be pressed between the two counter rotating rolls contains an overall amount of waste polymers or recycled polymers of 10 wt % to 100 wt %. Usage of waste or recycled polymers can reduce production costs.

The invention further pertains to grid like structures comprising two plies of parallel members, one on top of the other, lying crossed and being connected at the crossing points characterised in that it is produced using a process as described above.

Surprisingly it has also been found that the object of the invention i.e. to provide three dimensional structures in particular truss like structures can be achieved by a process comprising the steps of heating a quantity of a fusible material, heating is performed until the material has a viscosity sufficiently low to be used in a roll press forming process depositing a quantity of the material into the nip between a first and second counter rotating roll pressing the material between the two rolls characterised in that one of the two counter rotating rolls having a corrugated cross section running tangential around the surface of the roll and perpendicular to the rolls axis and said corrugated surface comprises grooves which intersect, the second of the two counter rotating rolls having solely a corrugated cross section running tangential around the surface of the second roll and perpendicular to the rolls axis and being complementary to the corrugated surface of the first roll.

Similar to the process for producing two dimensional structures it is preferred that the two counter rotating rolls are partially immersed in a cooling liquid, more preferably the two counter rotating rolls are half immersed in water.

The advantage of immersing the two counter rotating rolls in a cooling liquid is very efficient cooling of the pressed material which is still viscous without cooling. Thus the pressed material is solidified immediately after it leaves the counter rotating rolls. Further deformation of the material can thus be avoided. In addition the material detaches from the rolls very easily as the surface of the rolls on which the material is pressed is moistened. The process is a one step process that allows mass production of said structures in a continuous way.

The grooves which are located on one of the two corrugated counter rotating rolls intersect in an angle between 10° and 90° thus forming a rectangular or rhombical grid on the corrugated surface of the roll.

Additional grooves may be located along the top edge and lower edge of the corrugated surface of that roll of the two counter rotating rolls that comprises grooves. The structure resulting from such process would already have a high bending stiffness and high stability in one direction without being connected to a top or bottom layer to build a sandwiched article.

Not only one of the two rolls but both of the two counter rotating rolls may comprise grooves and the grooves on each roll intersect and form a rectangular or rhombical grid on both rolls. The rolls can be operated such that the rectangular or rhombical grids on both rolls coincide or intersect.

It is also possible that sinusoidal shaped grooves are milled on the rolls. The shape of the grooves can be triangular, rectangular, trapezoidal or curved. It has to be pointed out that said grooves not necessarily have a constant cross section or constant depth and that they may vary in shape and/or depth.

The material pressed between the two counter rotating rolls may be a metal alloy, preferably an aluminium alloy.

It is however preferred that the material to be pressed between the two counter rotating contoured rolls is a polymeric material and that the polymeric material is a composition of one or more polymer types. Basically all kinds of polymeric materials —provided it can be heated such that it will flow out of an extruder—can be used. It is also possible to use fibre reinforced thermoplastic material. The types of polymers introduced into the process are preferably selected from the group containing polyester, polyamide, polyethylene, polypropylene, polyvinylchloride, polystyrene and/or mixtures thereof.

More preferably the material pressed between the two counter rotating rolls contains an overall amount of waste polymers or recycled polymers of 10 wt % to 100 wt %.

The process according to the invention for example yields a truss like structure in which four bars come together at the top and the bottom of the grooves forming a pyramidal structure. The shape of the bars is determined by the grooves in the corrugated rolls.

The invention therefore also pertains to a truss-like structure comprising a corrugated grid characterised in that the structure is made in one piece and that the members of the structure do not have to be joined together. As this structure is produced in a continuous process it is also indefinite in length.

One of the advantages of the truss-like structure is that it can be formed easily to adapt to three dimensional shapes of the outer skins to which it shall impart stiffness after it has been bonded to the skins. The geometry of the connection points between the bars allows adjustment of the flexibility of the truss like structure according to the invention. By cutting the grooves so that only very little material forms the connections points a highly flexible structure may be obtained. Once the structure is connected to a top and bottom layer it will give stiffness to the sandwich construction. This stiffness thus does not depend on the connection between the bars. Here lies a major advantage compared with honeycomb structures and foams with their very limited formability.

Comparable to the grid like structure the truss like structure may comprise a metal alloy or an aluminium alloy. It is preferred however that the truss like structure comprises polymeric material which may be a composition of one or more polymer types. The polymeric material may also comprise fibre reinforced polymeric material. More preferably the truss like structure comprises an overall amount of waste polymers or recycled polymers of 10 wt % to 100 wt %.

The invention also encompasses a truss-like structure i.e. a corrugated grid or a grid containing regular grooves made in one piece and indefinite in length characterised in that it is produced by a process according to the invention.

The structures described herein are useful for a large variety of applications, e.g. reinforcement structures, as drainage mat connected to one or more filter fabrics or even as mass exchange medium in cooling towers or wet scrubbers. The truss like or grid like structures are particularly useful for sandwich articles comprising two or more layers one of them being said truss like or grid like structure according to the invention.

All processes described herein have one thing in common: The areas circumscribed by the two or three-dimensional structures could be all or partly covered by a film of the pressed material. Removing this residue to obtain open structures can be done by quickly cooling the structure and blasting the brittle films out of the structure. Blasting can be carried out by either sand blasting the residual material or by blasting particles of the same material the structure is made of onto the films. Other ways of removing this film are punching, cutting or heating the films with an hot air stream and subsequently blowing the film out.

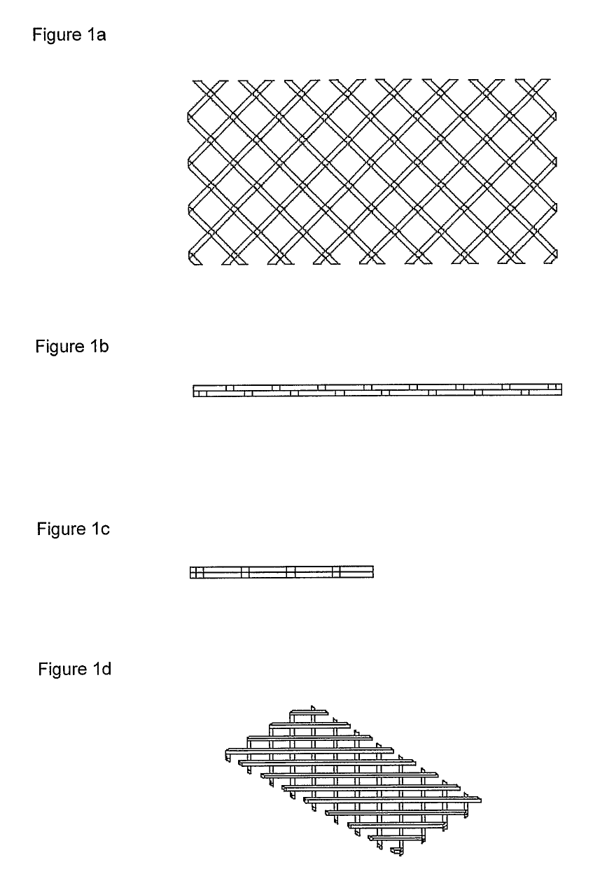

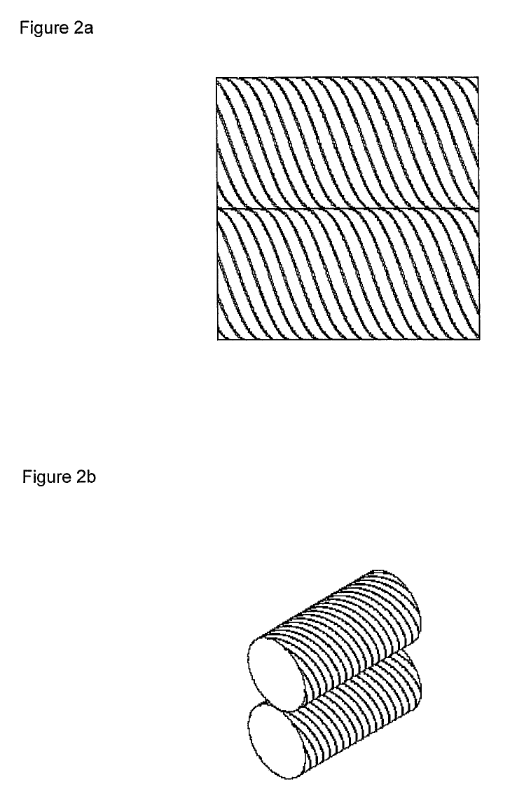

The invention is further illustrated by means of FIGS. 1a, 1b, 1c, 1d and 2a, 2b, as well as 3a, 3b, 3c, 3d and 4a, 4b. It should be noted that the invention is not limited to the embodiments shown in the figures.

FIGS. 1a, b and c show the two ply grid-like structure according to the invention from different views. 1a is a view from top, 1b from the longitudinal side, 1c from the transversal side and 1c is a perspective drawing of the structure

FIGS. 2a and 2b show a preferred embodiment of the two counter rotating rolls comprising grooves substantially parallel to each other which are used in the process for producing grid like structures. The distance between the grooves is essentially constant and the grooves run essentially in straight lines. 2a is a view from top and 2b is a perspective drawing of the two rolls.

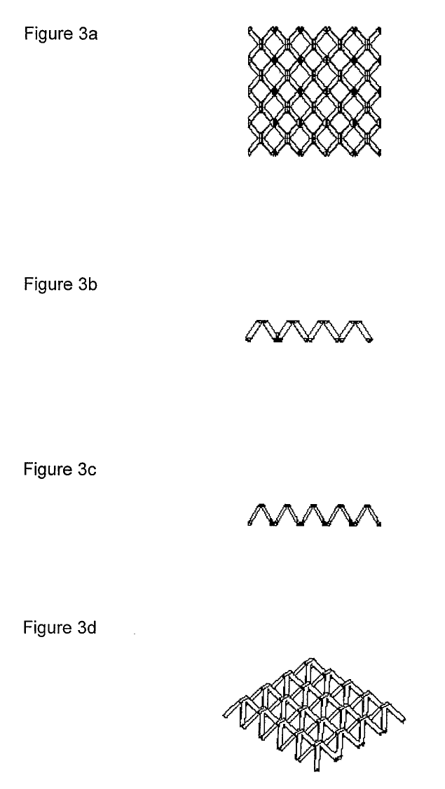

FIGS. 3a, b, c and d show the truss-like structure according to the invention from different views. 3a is a view from top, 3b from the longitudinal side, 3c from the transversal side and 3d a perspective drawing of the structure.

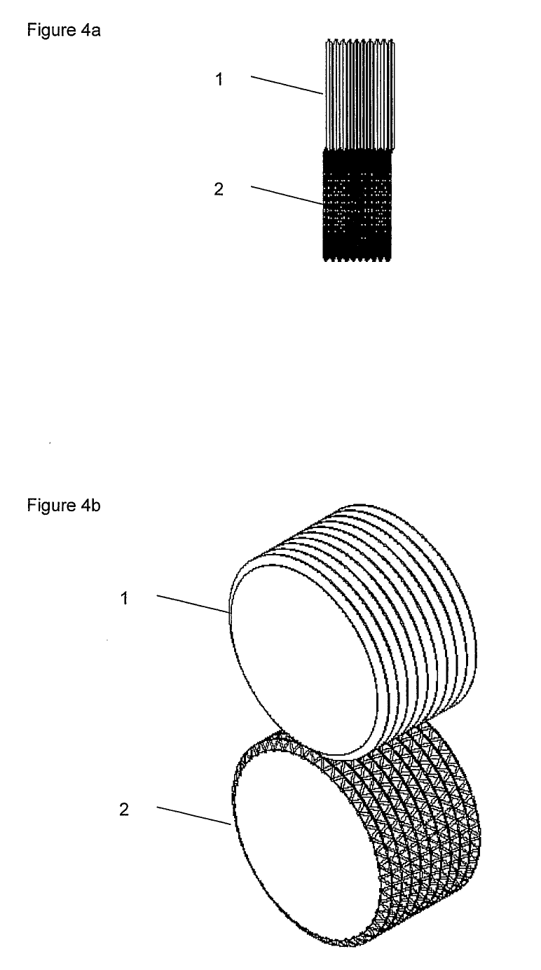

FIGS. 4a and 4b show a preferred embodiment of the two counter rotating rolls used for the production of truss like structures where one roll 2 of the two counter rotating rolls having a corrugated cross section running tangential around the surface of the roll and perpendicular to the rolls axis and said corrugated surface comprises grooves which intersect, the other roll 1 of the two counter rotating rolls having solely a corrugated cross section running tangential around the surface of the second roll and perpendicular to the rolls axis and being complementary to the corrugated surface of the first roll. One Roll 2 of the two corrugated rolls comprises grooves forming a rhombical grid on the corrugated surface of the roll, the other roll 1 has a corrugated surface without grooves on the corrugated surface as described above. FIG. 4a is a schematic view from top of the two corrugated counter rotating rolls and FIG. 4b is perspective drawing of the two rolls.

1.-24. (canceled)

25. Process for producing grid like structures comprising the steps of heating a quantity of a material, heating is performed until the material has a viscosity sufficiently low to be used in a roll press forming process, depositing a quantity of the material into the nip between two counter rotating rolls pressing the material between the two rolls characterised in that the two counter rotating rolls comprise grooves substantially parallel to each other, said grooves are arranged in an angle from 0 to 90° measured against the rolls circumferential direction which is perpendicular to the rolls centre axis and the grooves on the first and second roll cross each other when the rolls counter rotate.

26. Process according to claim 25 wherein the two counter rotating rolls are partially immersed in a cooling liquid.

27. Process according to claim 25 wherein the material to be pressed between the two counter rotating contoured rolls comprises a metal alloy.

28. Process according to claim 27 wherein the material to be pressed between the two counter rotating contoured rolls comprises an aluminium alloy.

29. Process according to claim 25 wherein the material to be pressed between the two counter rotating contoured rolls is a polymeric material and the polymeric material is a composition of one or more polymer types.

30. Process according to claim 29 wherein the composition of the polymeric material contains an overall amount of waste polymers or recycled polymers of 10 wt % to 100 wt %.

31. Process for producing a truss like structure comprising the steps of heating a quantity of a material, heating is performed until the material has a viscosity sufficiently low to be used in a roll press forming process, depositing a quantity of the material into the nip between two counter rotating rolls pressing the material between the two rolls characterised in that one of the two counter rotating rolls having a corrugated cross section running tangential around the surface of the roll and perpendicular to the rolls axis and said corrugated surface comprises grooves which intersect, the second of the two counter rotating rolls having solely a corrugated cross section running tangential around the surface of the second roll and perpendicular to the rolls axis and being complementary to the corrugated surface of the first roll.

32. Process according to claim 31 wherein the two counter rotating rolls are partially immersed in a cooling liquid.

33. Process for producing a truss like structure according to claim 31 wherein the grooves on the first of the two counter rotating rolls intersect in an angle between 10° and 90° thus forming a rectangular or rhombical grid on the corrugated surface of the roll.

34. Process for producing a truss like structure according to claim 34 wherein additional grooves are located along top edge and lower edge of the corrugated surface of the first of the two counter rotating rolls.

35. Process for producing a truss like structure according to claim 31 wherein the first and the second roll having a corrugated cross section running tangential around the surface of the roll and that said corrugated surface on the first of the two counter rotating rolls comprises grooves and that said corrugated surface on the second of the two counter rotating rolls also comprises grooves.

36. Process according to claim 31 wherein the material to be pressed between the two counter rotating contoured rolls comprises a metal alloy.

37. Process according to claim 31 wherein the material to be pressed between the two counter rotating contoured rolls comprises an aluminium alloy.

38. Process according to claim 31 wherein the material to be pressed between the two counter rotating contoured rolls is a polymeric material and the polymeric material is a composition of one or more polymer types.

39. Process according to claim 38 wherein the composition of the polymeric material contains an overall amount of waste polymers or recycled polymers of 10 wt % to 100 wt %.
